(19) United States
(12) Patent Application Publication
(10) Pub. No.: US 2008/0260970 A1
(43) Pub. Date: Oct. 23, 2008

(54) Organic Electroluminescence Device

(76) Inventors: Kenichi Nakayama, Yamagata (JP); Masaaki Yokoyama, Osaka (JP); Shinichi Morishima, Ibaraki (JP)

Correspondence Address: SUGHRUE MION, PLLC, 2100 PENNSYLVANIA AVENUE, N.W., SUITE 800, WASHINGTON, DC, 20037, US

(21) Appl. No.: 11/909,296

(22) PCT Filed: Mar. 27, 2006
(86) PCT No.: PCT/JP06/06988

§ 371 Date: Dec. 10, 2007

(30) Foreign Application Priority Data
Mar. 28, 2005 (JP) 2005-091263

(51) Int. Cl. C09K 19/00; H01J 1/63

(52) U.S. Cl. 428/1.1; 428/704

(57) ABSTRACT

An organic electroluminescence device having a light emitting layer between an anode and a cathode wherein the device has a layer (L) between said cathode and said light emitting layer so as to contact the cathode, and the layer (L) comprises an organic compound (A) containing an aromatic hydrocarbon ring or hetero ring and a carbonyl group and at least one metal (B) selected from alkaline earth metals and group III metals.

### TECHNICAL FIELD

The present invention relates to an organic electroluminescence device (hereinafter, referred to as organic EL device in some cases).

### BACKGROUND ART

An organic EL device is an EL device using an organic material as a light emitting material, and has a light emitting layer between an anode and a cathode as a basic structure.

For improvement of its performance, there is disclosed, for example, an organic EL device having a layer containing an organic compound, alkali metal and the like between the above-described cathode and light emitting layer so as to contact the cathode (Japanese Patent Application Laid-Open (JP-A) No. 10-270171).

The above-described known device, however, is not sufficient in electron injectability, durability and the like yet for practical application.

### DISCLOSURE OF THE INVENTION

The present invention has an object of providing an organic EL device excellent in electron injectability, durability and the like.

The present invention provides an organic electroluminescence device having a light emitting layer between an anode and a cathode wherein the device has a layer (L) between said cathode and said light emitting layer so as to contact the cathode, and the layer (L) comprises an organic compound (A) containing an aromatic hydrocarbon ring or hetero ring and a carbonyl group and a metal (B) selected from alkaline earth metals and group III metals.

Further, the present invention provides an organic electroluminescence device having a light emitting layer between an anode and a cathode wherein the device has a layer (L) between said cathode and said light emitting layer so as to contact the cathode, and the layer (L) is obtained by using an organic compound (A) containing an aromatic hydrocarbon ring or hetero ring and a carbonyl group and a metal (B) selected from alkaline earth metals and group III metals.

### BRIEF EXPLANATION OF DRAWINGS

FIG. 1 is a schematic view showing a cross-section of a lamination structure examples of an organic electroluminescence device of the present invention.

FIG. 2 is a graph showing current density-voltage properties of an organic electroluminescence device of the present invention and a comparative example.

FIG. 3 is a graph showing luminance-voltage properties of an organic electroluminescence device of the present invention and a comparative example.

FIG. 4 is a graph showing current density-time properties of an organic electroluminescence device of the present invention and a comparative example.

FIG. 5 is a graph showing absorption spectra of a mixture contained in a layer (L) used in an organic electroluminescence device of the present invention and a comparative example.

FIG. 6 is a graph showing an ESR spectrum of a mixture contained in a layer (L) used in an organic electroluminescence device of the present invention.

FIG. 7 is a graph showing an absorption spectrum of a comparative example.

FIG. 8 is a graph showing an ESR spectrum of a comparative example.

### BEST MODES FOR CARRYING OUT THE INVENTION

The organic EL device of the present invention is an organic electroluminescence device having a light emitting layer between an anode and a cathode in which the device has a layer (L) between the above-described cathode and the above-described light emitting layer so as to contact the cathode. That is, the device of the present invention has a lamination structure represented by cathode/layer (L)/light emitting layer/anode. It is necessary that the cathode and the layer (L) are in contact. Between the layer (L) and the light emitting layer, and between the light emitting layer and the anode, other layers may be present.

The cathode, layer (L), light emitting layer and anode will be illustrated in turn below.

The material of the cathode in the organic EL device of the present invention includes inorganic semiconductors such as metals, graphite or graphite interlaminar compounds, ZnO (zinc oxide) and the like, electrically conductive transparent electrodes such as ITO (indium.tin.oxide), IZO (indium.zinc.oxide) and the like, metal oxides such as strontium oxide, barium oxide, and the like.

Examples of the metal include alkali metals such as lithium, sodium, potassium, rubidium, cesium and the like; alkaline earth metals such as beryllium, magnesium, calcium, strontium, barium and the like; transition metals such as gold, silver, platinum, copper, manganese, titanium, cobalt, nickel, tungsten and the like; tin, aluminum, scandium, vanadium, zinc, yttrium, indium, cerium, samarium, europium, terbium, ytterbium; and alloys composed of two or more metals of them, and the like.

Examples of the alloy include a magnesium-silver alloy, magnesium-indium alloy, magnesium-aluminum alloy, indium-silver alloy, lithium-aluminum alloy, lithium-magnesium alloy, lithium-indium alloy, calcium-aluminum alloy and the like.

The cathode may have a lamination structure composed of two or more layers. For example, cathodes obtained by laminating a metal, alloy and the like on a layer made of a metal fluoride such as lithium fluoride, cesium fluoride and the like or a conductive polymer, or a layer having an average film thickness of 5 nm or less made of an organic insulating material and the like, and cathodes obtained by laminating aluminum on a calcium layer, and the like, are mentioned.

The organic EL device of the present invention has a layer (L) between a cathode and a light emitting layer so as to contact the cathode. The film thickness of the layer (L) is usually about 0.1 nm to 500 nm, preferably 1 nm to 100 nm, more preferably 5 nm to 20 nm.

The layer (L) contains an organic compound (A) and a metal (B) selected from alkaline earth metals and group III metals, or is obtained by using an organic compound (A) containing an aromatic hydrocarbon ring or hetero ring and a carbonyl group and a metal (B) selected from alkaline earth metals and group III metals. Two or more layers (L) may be laminated.

Examples of the alkaline earth metal in the metal (B) used in the layer (L) include magnesium, calcium, strontium and barium, and the group III metal includes aluminum, gallium, indium and thallium, and from the standpoint of durability, preferable are group III metals, and more preferable is indium.

The organic compound (A) used in the layer (L) is an organic compound containing an aromatic hydrocarbon ring or hetero ring and a carbonyl group.

Here, the aromatic hydrocarbon ring includes a benzene ring, naphthalene ring, anthracene ring, tetracene ring, pentacene ring, pyrene, phenanthrene and the like, and the hetero ring includes a pyridine ring, bipyridine ring, phenanthroline ring, quinoline ring, isoquinoline ring, thiophene ring, furan ring, pyrrole ring and the like. The aromatic hydrocarbon ring and hetero ring may have a substituent such as alkyl groups, alkoxy groups, alkylthio groups and the like.

As the organic compound (A), the following formulae (1), (2), (3) and (4) are preferable.

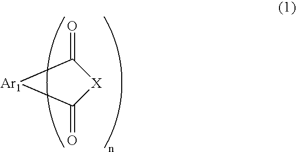

(wherein, Ar₁ represents an organic group containing an aromatic hydrocarbon ring or hetero ring. X represents O or NH. n represents an integer of 1 or more and 4 or less. When there are a plurality of Xs, they may be the same or different.)

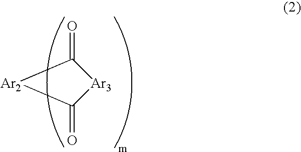

(wherein, Ar₂ and Ar₃ represent each independently an organic group containing an aromatic hydrocarbon ring or hetero ring. m represents an integer of 1 or more and 4 or less. When there are a plurality of Ar₃s, they may be the same or different.)

Ar₂ is a 2m-valent organic group, and Ar₃ is a di-valent organic group.

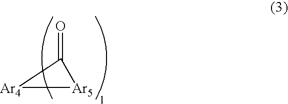

(wherein, Ar₄ and Ar₅ represent each independently an organic group containing an aromatic hydrocarbon ring or hetero ring. 1 represents an integer of 1 or more and 4 or less. Ar₅s may be the same or different.)

Ar₄ is a 21-valent organic group, and Ar₅ is a di-valent organic group.

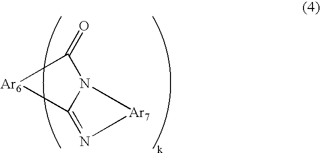

(wherein, Ar₆ and Ar₇ represent each independently an organic group containing an aromatic hydrocarbon ring or hetero ring. k represents an integer of 1 or more and 4 or less. When there are a plurality of Ar₇s, they may be the same or different.).

Ar₆ is a 2 k-valent organic group, and Ar₇ is a di-valent organic group.

As the compound of the formula (1), NTCDA (Naphthalene-1,8:4,5-tetracarboxylic dianhydride), PTCDA (Perylene-3,4,9,10-tetracarboxylic dianhydride), NTCDI (3,4,7,8-naphthalene-tetracarboxylic-diimide) and the like are mentioned.

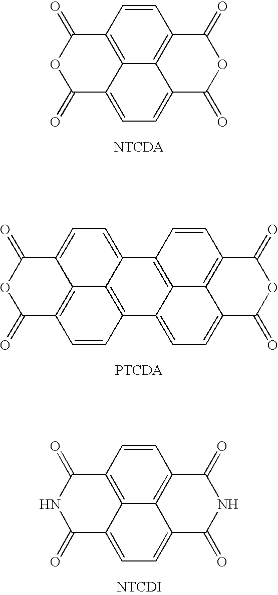

As the compound of the formula (2), PQ4 (5,7,12,14-Pentacentetrone) and the like are mentioned.

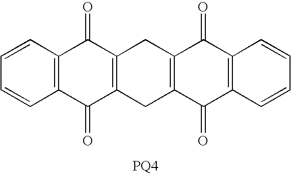

As the compound of the formula (3), isoviolanthrone (9,18-dihydrobenzo[rst]phenanthro[10,1,2-cde]pentaphene-9,1 8-dione) and the like are mentioned.

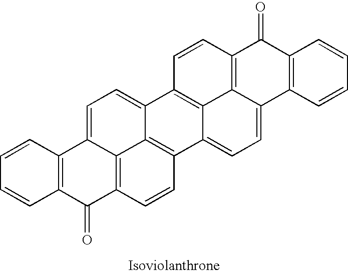

As the compound of the formula (4), PTCBI (3,4,9,10-perylenetetracarboxylic bis-benzimidazole) and the like are mentioned.

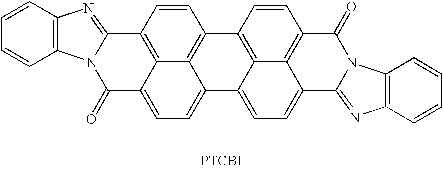

Of them, compounds of the formula (1) are preferable, tetracarboxylic anhydride and tetracarboxylic imide are more preferable, NTCDA, PTCDA and NTCDI are further preferable.

The number of carbonyl groups in the organic compound (A) is 1 or more, and preferably in the range of 1 to 8.

The organic compounds (A) and the metals (B) may be used each in combination of two or more.

The total weight of the organic compound (A) and the metal (B) in the layer (L) is usually 50 wt % or more, preferably 80 wt % or more, more preferably 90 wt % or more based on the total weight of the layer (L).

The number of metal atoms in the metal (B) per carbonyl group in the organic compound (A) is preferably about 0.025 to 25, more preferably 0.06 to 2.25, further preferably 0.16 to 0.38.

From the standpoint of lowering of driving voltage, the electric conductivity of a mixture obtained from the organic compound (A) and the metal (B) is preferably 10⁻⁶ S/cm or more, more preferably 10⁻⁴ S/cm or more, further preferably 10⁻² S/cm or more.

In a mixture used for measurement of electric conductivity, the number ratio of metal atoms in the metal (B) per carbonyl group in the organic compound (A) in the mixture is set equal to the number ratio in the layer (L).

From the standpoint of electron injectability, the absorption peak wavelength of a thin film composed of the organic compound (A) and the metal (B) is larger preferably by 5 nm or more, more preferably by 10 nm or more, further preferably by 30 nm or more than the absorption peak wavelength of a thin film composed of the organic compound (A).

As the absorption peak of the organic compound (A), when the organic compound (A) is composed of two or more compounds, the absorption peak of an organic compound having the largest number of molecules in the organic compound (A) (showing the maximum mol ratio in the organic compound (A)) is used. In a mixture used for measurement of absorption peak wavelength, the number ratio of metal atoms in the metal (B) per carbonyl group in the organic compound (A) in the mixture is set equal to the number ratio in the layer (L).

The light emitting layer in the organic EL device of the present invention usually contains an organic light emitter. As the organic light emitter, organic fluorescent molecules and polymer fluorescent substances usually used in organic EL devices can be used.

Exemplified as the organic fluorescent molecule are, for example, benzooxazole derivatives, benzoimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, perylene derivatives, perynone derivatives, oxadiazole derivatives, aldazine derivatives, pyralydine derivatives, cyclopentadiene derivatives, bisstyrylanthracene derivatives, quinacridone derivatives, pyrrolopyridine derivatives, thiadiazolopyridine derivatives, cyclopentadiene derivatives, styrylamine derivatives, aromatic dimethylidyne compounds, metal complexes and rare earth complexes of 8-quinolinol derivatives, various metal complexes typified by Ir and Pt complexes. More specifically, compounds disclosed in JP-A Nos. 63-70257, 63-175860, 2-135359, 2-135361, 2-209988, 3-37992 and 3-152184 are suitably used.

As the polymer fluorescent substance, preferably used are polymer fluorescent substances having a molecule structure in which a π electron system is delocalized along the molecule chain, showing fluorescence in solid state, and having a polystyrene-reduced number average molecular weight of 1×10⁴ to 1×10⁷ such as polyarylene, polyarylenevinylene and the like are preferably used. Specifically, materials described in JP-A Nos. 3-244630, 5-202355, 6-73374, 7-278276, 9-45478, WO 99/20675, WO 99/48160, WO 99/13692, WO 00/55927, WO 97/05184, WO 98/06773, WO 99/54385, WO 99/54943, WO 00/0665, WO 00/46321, WO98/27136, WO99/24526, WO 00/22026, WO00/22027, WO 00/35987, WO 01/34722, GB 2340304A, JP-A Nos. 10-324870, 11-176576, 2000-34476, 2000-136379, 2000-104057, 2000-154334, 2000-169839 and the like are exemplified.

The optimum value of the film thickness of a light emitting layer varies depending on the material to be used, and may be advantageously selected so as to give suitable driving voltage and light emission efficiency, and at least thickness not causing generation of pin holes is necessary, and too large thickness is undesirable since then the driving voltage of a device increases. Accordingly, the thickness of the light emitting layer is for example 1 nm to 1 μm, preferably 2 nm to 500 nm, further preferably 5 nm to 200 nm.

In the present invention, it is preferable that at least one of an anode and a cathode is transparent or semi-transparent.

It is preferable that an anode is transparent or semi-transparent. As the material of the anode, electrically conductive metal oxide films, semi-transparent metal thin films and the like are used. Specifically, films (NESA and the like) manufactured by using indium oxide, zinc oxide, tin oxide, and composite thereof: indium.tin.oxide (ITO), indium.zinc.oxide and the like, and gold, platinum, silver, copper and the like, are used, and preferable are ITO, indium.zinc.oxide and tin oxide. As the anode, organic transparent conductive films made of polyaniline or its derivatives, polythiophene or its derivatives and the like may be used.

The film thickness of the anode can be appropriately selected taking light permeability and electric conductivity into consideration, and is for example 10 nm to 10 μm, preferably 20 nm to 1 μm, further preferably 50 nm to 500 nm.

The organic EL device of the present invention may further have layers such as a hole transporting layer, electron transporting layer and the like, in addition to the light emitting layer, anode, cathode and layer (L). For example, structures as described below are mentioned specifically.

a) anode/hole transporting layer/light emitting layer/electron transporting layer/layer (L)/cathode

b) anode/hole transporting layer/light emitting layer/layer (L)/cathode

c) anode/light emitting layer/layer (L)/cathode

Here, the hole transporting layer is a layer having a function of transporting holes, and the electron transporting layer is a layer having a function of transporting electrons. The hole transporting layer and electron transporting layer are called collectively a charge transporting layer. Among charge transporting layers, those having a function of improving charge injection efficiency from an electrode is in general called particularly a charge injection layer (hole injection layer, electron injection layer). Among charge transporting layers, that existing between an anode and a light emitting layer and having a function of blocking electrons injected from a cathode is in general called particularly an electron blocking layer, and that existing between a cathode and a light emitting layer and having a function of blocking holes injected from an anode is in general called particularly a hole blocking layer, in some cases. Particularly, among charge injection layers, that having a function of decreasing lowering of the light emission intensity of a light emitting layer caused by laminating an electron transporting layer, hole transporting layer, layer (L) or electrode is in general called an extinction preventing layer in some cases.

In the present invention, each two or more layers of the light emitting layer, anode, cathode, hole transporting layer and electron transporting layer may be independently used. When two or more layers of respective layers are used, they can be appropriately used in view of light emission efficiency and device life without particularly restricting a position of use of a second layer.

When the organic EL device of the present invention has a hole transporting layer, preferably used as the hole transporting material used for the hole transporting layer are aromatic amine compounds such as N,N-diphenyl-N,N-bis(3-methylphenyl)-1,1-biphenyl-4,4-diamine (TPD) and the like, hydrazone compounds, metallophthalocyanines, porphyrins, styrylamine compounds, polyvinyl carbazole, polysilane (Appl, Phys, Lett. 59, 2760 (1991)), suspension of poly(3,4)ethylenedioxythiophene/polystyrenesulfonic acid (manufactured by Bayer, Bytron PTP AI 4083), and the like.

Specifically, exemplified as the hole transporting material are those described in JP-A Nos. 63-70257, 63-175860, 2-135359, 2-135361, 2-209988, 2-311591, 3-37992, 3-152184, 11-35687, 11-217392 and 2000-80167, and the like.

The optimum value of the film thickness of a hole transporting layer varies depending on the material to be used, and may be advantageously selected so as to give suitable driving voltage and light emission efficiency, and at least thickness not causing generation of pin holes is necessary, and too large thickness is undesirable since then the driving voltage of a device increases. Accordingly, the thickness of the hole transporting layer is for example 1 nm to 1 μm, preferably 2 nm to 500 nm, further preferably 5 nm to 200 nm.

When the organic EL device of the present invention has an electron transporting layer, exemplified as the electron transporting material used for the electron transporting layer are triazole derivatives, oxazole derivatives, oxadiazole derivatives, fluorenone derivatives, anthraquinodimethane derivatives, anthrone derivatives, diphenylquinone derivatives, thiopyrane dioxide derivatives, carbodiimide derivatives, fluorenylidenemethane derivatives, distyrylpyrazine derivatives; heterocyclic tetracarboxylic anhydrides such as naphthaleneperylene and the like; phthalocyanine derivatives, metal complexes of 8-quinolinol derivatives, various metal complexes typified by metal complexes containing metallophthalocyanine, benzooxazole and benzothiazole as a ligand, benzoquinone or its derivatives, naphthoquinone or its derivatives, anthraquinone or its derivatives, diphenyldicyanoethylene or its derivatives, diphenoquinone derivatives, polyquinoline or its derivatives, polyquinoxaline or its derivatives, polyfluorene or its derivatives, bathocuproine or its derivatives, and the like.

Specifically, those described in JP-A Nos. 63-70257, 63-175860, 2-135359, 2-135361, 2-209988, 3-37992 and 3-152184, and the like are exemplified.

The optimum value of the film thickness of an electron transporting layer varies depending on the material to be used, and may be advantageously selected so as to give suitable driving voltage and light emission efficiency, and at least thickness not causing generation of pin holes is necessary, and too large thickness is undesirable since then the driving voltage of a device increases. Accordingly, the thickness of the electron transporting layer is for example 1 nm to 1 μm, preferably 2 nm to 500 nm, further preferably 5 nm to 200 nm.

The organic EL device of the present invention may have a protective layer outside of an anode or cathode. For use of the organic EL device stably for a long period of time, it is preferable to fit a protective layer and/or protective cover for protecting the device from the outside. When a protective layer is present at the side of a cathode, a protective layer is fitted, after manufacturing of a cathode, from the side of the cathode so as to be sandwiched with a substrate on which the device is laminated.

As the material of the protective layer, polymer compounds, metal oxides, metal fluorides, metal borides and the like can be used. As the protective cover, there can be used glass plates, plastic plates having a surface on which a water permeability coefficient-lowering treatment has been performed, and the like. A method for pasting the cover to a device substrate with a thermosetting resin or photo-curing resin to attain sealing is suitably used. When a space is maintained using a spacer, it is easy to prevent flawing of a device. When an inert gas such as nitrogen and argon is enclosed in this space, oxidation of a cathode can be prevented, further, by placing a desiccant agent such as barium oxide and the like in this space, it becomes easy to suppress imparting damage to a device by moisture adsorbed in a production process. Also, by forming a lamination film composed of at least a pair of organic layer/inorganic layer on an organic EL device, a film protecting the organic EL device can be formed. It is preferable to adopt any one or more strategies of them.

Next, a method for producing the organic EL device of the present invention will be illustrated.

The device of the present invention has, as described above, a lamination structure represented by

cathode/layer (L)/light emitting layer/anode and may have other layer between the layer (L) and the light emitting layer, and between the light emitting layer and the anode.

Hereinafter, methods for producing a hole transporting layer and an electron transporting layer among a cathode, layer (L), light emitting layer, anode and, layers to be used if necessary, will be illustrated in turn.

In the present invention, the method for manufacturing a cathode is not particularly restricted, and for example, a cathode is formed by a vacuum vapor deposition method, sputtering method, electron beam method and the like with a metal.

As the method for forming a layer (L), a vacuum vapor deposition method is preferably used. As the vacuum vapor deposition, methods of co-vapor depositing a metal (B), an organic compound (A) and the like are mentioned. Specifically, raw materials such as a metal (B), an organic compound (A) and the like are filled in a crucible, boat and the like and the raw materials are heated by resistive heating to evaporate. In this operation, by monitoring and controlling the sedimentation speed of a metal (B) and an organic compound (A), co-vapor deposition at any ratio is made possible, and any formulation ratio and film thickness can be obtained.

As the vacuum vapor deposition, there is also mentioned a method of laminating an organic compound (A) before vapor-depositing a metal (B), in addition to the co-vapor deposition. By this, a metal can be diffused in an organic compound thereby forming a layer. Further, in this case, the method for laminating an organic compound (A) is not limited to a vacuum vapor deposition method, and there are methods in which an organic compound (A) is dissolved or dispersed in a solvent to prepare a solution which is applied (on a substrate). The application method include, but not particularly limited to, a drop cast method, spin coat method, inkjet method and the like. For vapor deposition of a metal (B), there are a sputtering method, electron beam method, ion plating method, laser ablation method and the like.

As the method for forming a light emitting layer of the organic electroluminescence device of the present invention, there are exemplified a vacuum vapor deposition method when the organic light emitter is an organic fluorescent molecule, and a method of application from solution when the organic light emitter is a polymer fluorescent substance. In the case of application from solution, though a solution of a light emitter may be used, a mixed solution with a polymer binder may also be used.

The solvent to be used for film formation from solution is not particularly restricted providing it dissolves a light emitter. Exemplified as the solvent are chlorine-based solvents such as chloroform, methylene chloride, dichloroethane and the like; ether solvents such as tetrahydrofuran and the like; aromatic hydrocarbon solvents such as toluene, xylene and the like; ketone solvents such as acetone, methyl ethyl ketone and the like; and ester solvents such as ethyl acetate, butyl acetate, ethylcellosolve acetate and the like.

As the method for film formation from solution, application methods can be used such as a spin coat method, casting method, microgravure coat method, gravure coat method, bar coat method, roll coat method, wire bar coat method, dip coat method, spray coat method, screen printing method, flexographic printing method, offset printing method, inkjet printing method and the like from solution.

As the polymer binder to be mixed, those not extremely disturbing light emitability are preferable, and those showing no intense absorption for visible light are suitably used. As the polymer binder, exemplified are polycarbonate, polyacrylate, polymethyl acrylate, polymethyl methacrylate, polystyrene, polyvinyl chloride, polysiloxane and the like. Further, as the polymer binder, polymer hole transporting materials such as polyvinyl carbazole or its derivatives, polysilane or its derivatives, polysiloxane derivatives having an aromatic amine compound group at the side chain or main chain, polyaniline or its derivatives, polythiophene or its derivatives, poly(p-phenylenevinylene) or its derivatives, poly(2,5-thienylenevinylene) or its derivatives, and the like may be used.

As the method for manufacturing an anode, a vacuum vapor deposition method, sputtering method, ion plating method, plating method and the like are mentioned.

When the organic EL device of the present invention has a hole transporting layer, a method for forming the layer will be described below. In the case of use of a hole transporting material of low molecular weight, film formations by vacuum vapor deposition, application from solution, and the like are mentioned. In the case of application from solution, though a solution of a hole transporting material may be used, also a mixed solution with a polymer binder may be used.

The solvent to be used for film formation from solution is not particularly restricted providing it dissolves a hole transporting material. Exemplified as the solvent are chlorine-based solvents such as chloroform, methylene chloride, dichloroethane and the like; ether solvents such as tetrahydrofuran and the like; aromatic hydrocarbon solvents such as toluene, xylene and the like; ketone solvents such as acetone, methyl ethyl ketone and the like; and ester solvents such as ethyl acetate, butyl acetate, ethylcellosolve acetate and the like.

As the method for film formation from solution, application methods can be used such as a spin coat method, casting method, microgravure coat method, gravure coat method, bar coat method, roll coat method, wire bar coat method, dip coat method, spray coat method, screen printing method, flexographic printing method, offset printing method, inkjet printing method and the like from solution.

As the polymer binder to be mixed, those not extremely disturbing charge transportation are preferable, and those showing no intense absorption for visible light are suitably used. As the polymer binder, exemplified are polycarbonate, polyacrylate, polymethyl acrylate, polymethyl methacrylate, polystyrene, polyvinyl chloride, polysiloxane and the like. Further, as the polymer binder, polymer hole transporting materials such as polyvinyl carbazole or its derivatives, polysilane or its derivatives, polysiloxane derivatives having an aromatic amine compound group at the side chain or main chain, polyaniline or its derivatives, polythiophene or its derivatives, poly(p-phenylenevinylene) or its derivatives, poly(2,5-thienylenevinylene) or its derivatives, and the like may be used.

When the organic EL device of the present invention has an electron transporting layer, the method for forming an electron transporting layer is not particularly restricted, and in the case of an electron transporting material of low molecular weight, exemplified are a vacuum vapor deposition method from powder and a method of film formation from solution or melted state, and in the case of an electron transporting material of high molecular weight, exemplified is a method of film formation from solution or melted state, respectively. In film formation from solution or melted state, a polymer binder may be used together.

The solvent to be used for film formation from solution is not particularly restricted providing it dissolves an electron transporting material and/or a polymer binder. Exemplified as the solvent are chlorine-based solvents such as chloroform, methylene chloride, dichloroethane and the like; ether solvents such as tetrahydrofuran and the like; aromatic hydrocarbon solvents such as toluene, xylene and the like; ketone solvents such as acetone, methyl ethyl ketone and the like; and ester solvents such as ethyl acetate, butyl acetate, ethylcellosolve acetate and the like.

As the method for film formation from solution or melted state, application methods can be used such as a spin coat method, casting method, microgravure coat method, gravure coat method, bar coat method, roll coat method, wire bar coat method, dip coat method, spray coat method, screen printing method, flexographic printing method, offset printing method, inkjet printing method and the like.

As the polymer binder to be mixed, those not extremely disturbing charge transportation are preferable, and those showing no intense absorption for visible light are suitably used. As the polymer binder, exemplified are poly(N-vinylcarbazole), polyaniline or its derivatives, polythiophene or its derivatives, poly(p-phenylenevinylene) or its derivatives, poly(2,5-thienylenevinylene) or its derivatives, polycarbonate, polyacrylate, polymethyl acrylate, polymethyl methacrylate, polystyrene, polyvinyl chloride, polysiloxane and the like.

For obtaining the organic EL device of the present invention, a cathode, layer (L), (if necessary, electron transporting layer and the like), light emitting layer, (if necessary, electron transporting layer and the like) and anode may be produced in this order, or may be produced in the reverse order.

In forming the organic EL device of the present invention, a substrate is usually used, and advantageous as the substrate are those which do not change in forming an electrode and forming a layer of an organic substance, and exemplified are glass, plastic, polymer film, silicon substrate and the like. In the case of an opaque substrate, it is preferable that the opposite electrode is transparent or semi-transparent.

Next, examples will be provided to illustrate the present invention further in detail, but the present invention is no limited to these examples.

### SYNTHESIS EXAMPLE 1

### Synthesis of Polymer

Poly(9,9-dioctylfluorene) (PFO) was synthesized by a method described in WO 00/53656. This PFO had a number average molecular weight of 4.8×10⁴. Poly(2,7-(9,9-dioctylfluorene)-alt-(1,4-phenylene-((4-sec butylphenyl)imino)-1,4-phenylene)) (TFB) was synthesized by a method described in WO 00/55927. This TFB had a number average molecular weight of 1.8×10⁴.

### EXAMPLE 1

The polymers PFO and TFB in Synthesis Example 1 were dissolved in toluene to prepare an application solution (The concentrations of PFO and TFB in the application solution were each 1.5 wt %).

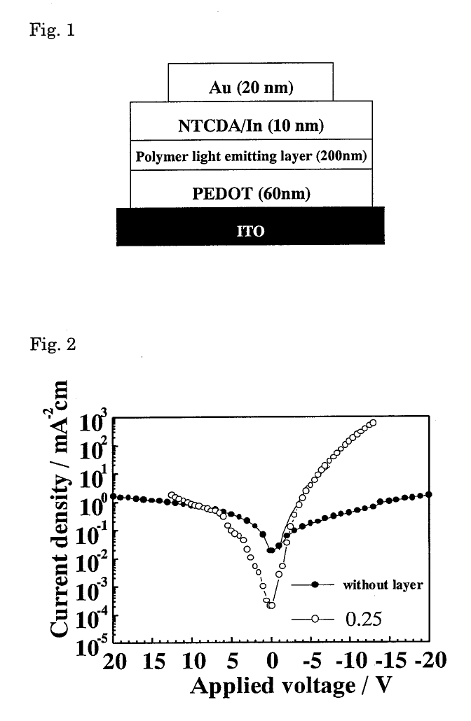

On a glass substrate carrying an ITO film of a thickness of 150 nm formed by a sputtering method, a suspension of poly(3,4)ethylenedioxythiophene/polystyrenesulfonic acid (manufactured by Bayer, Bytron P TP AI 4083) was spin-coated to form a film of a thickness of 60 nm, and dried on a hot plate at 200° C. for 10 minutes. Thereon, the above-described application solution was spin-coated to form a light emitting layer having a thickness of 200 nm. As the layer (L) (electron injection layer), NTCDA and indium were co-vapor-deposited at sedimentation speeds of 0.4 nm/s and 0.02 nm/s, respectively, so as to give a film thickness of 10 nm together, further, gold was vapor-deposited as a cathode of a thickness of 20 nm, manufacturing an organic EL device. The degree of vacuum in vapor deposition was 1.0×10⁻⁵ Torr or less in all cases. The proportion of an indium atom per mole of this NTCDA was one (0.25 indium atoms per carbonyl group) (FIG. 1).

The device was removed from the vapor deposition apparatus, and immediately, a current-voltage property was measured.

On the resultant device, a minus electrode was disposed at the ITO side and a plus electrode was disposed at the gold side, and a current density of 120 mA/cm² was shown when the voltage was −10 V (FIG. 2).

### EXAMPLE 2

The polymers PFO and TFB in Synthesis Example 1 were dissolved in toluene to prepare an application solution (The concentrations of PFO and TFB in the application solution were each 1.5 wt %).

On a glass substrate carrying an ITO film of a thickness of 150 nm formed by a sputtering method, a suspension of poly(3,4)ethylenedioxythiophene/polystyrenesulfonic acid (manufactured by Bayer, Bytron P TP AI 4083) was spin-coated to form a film of a thickness of 60 nm, and dried on a hot plate at 200° C. for 10 minutes. Thereon, the above-described application solution was spin-coated to form a light emitting layer having a thickness of 200 nm. Thereon, bathocuproine (BCP) was vapor-deposited at a sedimentation speed of 0.45 nm/s as an electron transporting layer (extinction preventing layer) with a thickness of 40 nm. Further, as the layer (L), NTCDA and indium were co-vapor-deposited at sedimentation speeds of 0.4 nm/s and 0.02 nm/s, respectively, so as to give a film thickness of 10 nm together. Further, gold was vapor-deposited as a cathode of a thickness of 20 nm, manufacturing an organic EL device. The degree of vacuum in vapor deposition was 1.0×10⁻⁵ Torr or less in all cases. The proportion of an indium atom per mole of this NTCDA was one (0.25 indium atoms per carbonyl group).

The device was removed from the vapor deposition apparatus, and immediately, a current-voltage property was measured.

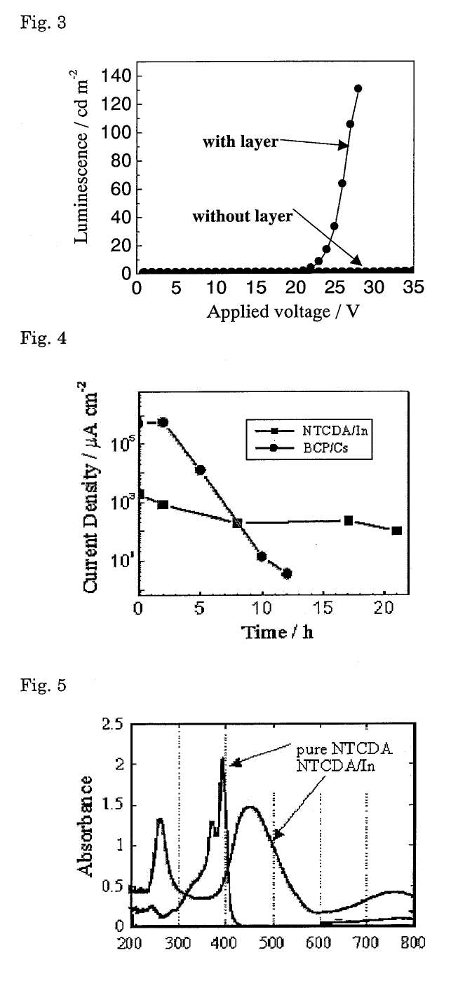

On the resultant device, a plus electrode was disposed at the ITO side and a minus electrode was disposed at the gold side, and a luminance of 130 cm/m² was shown when the voltage was 28 V (FIG. 3).

For evaluating stability of electric conductivity, change by time of current density in atmosphere was measured.

The ratio of the initial current value to the current value after 10 hours was 9.0 (FIG. 4).

### COMPARATIVE EXAMPLE 1

The same device as in Example 1 excepting no vapor deposition of a layer (L) was manufactured.

On the resultant device, a minus electrode was disposed at the ITO side and a plus electrode was disposed at the gold side, and a current density of 0.4 mA/cm² was shown when the voltage was −10 V. Apparently, the current density falls and electrons are not injected, as compared with the case of insertion of an electron injection layer (FIG. 2).

### COMPARATIVE EXAMPLE 2

The same device as in Example 2 excepting no vapor deposition of a layer (L) was manufactured.

On the resultant device, a plus electrode was disposed at the ITO side and a minus electrode was disposed at the gold side, and a luminance of 1 cd/m² was shown when the voltage was 28V. Apparently, the luminance falls and electrons are not injected efficiently, as compared with the case of insertion of an electron injection layer (FIG. 3).

### COMPARATIVE EXAMPLE 3

In the device of Example 2, BCP and cesium were co-vapor-deposited at sedimentation speeds of 0.4 nm/s and 0.1 nm/s, respectively, so as to give a film thickness of 10 nm together instead of a co-vapor deposition layer of NTCDA and indium contacting the cathode. For evaluating stability of electric conductivity, change by time of current density in atmosphere was measured. The ratio of the initial current value to the current value after 10 hours was 40000. Because of significant change as compared with Example 2, this device is judged to be instable under atmosphere (FIG. 4).

### EXAMPLE 3

### Manufacturing of Sample for Measuring Absorption Spectrum, ESR Spectrum

A washed glass substrate was set on a vacuum vapor deposition machine, and as the layer (L), NTCDA and indium were co-vapor-deposited at sedimentation speeds of 0.4 nm/s and 0.02 nm/s, respectively, so as to give a film thickness of 200 nm together. The proportion of an indium atom per mole of this NTCDA molecule was one (0.25 indium atoms per carbonyl group). On the other hand, a sample was also manufactured by vapor-depositing NTCDA at a sedimentation speed of 0.4 nm/s so as to give a film thickness of 200 nm without vapor deposition of a metal. The degree of vacuum was 1.0×10⁻⁵ Torr or less in all cases.

### (Measurement of Absorption Spectrum)

The absorption spectrum was measured by an ultraviolet-visible absorption spectrum measuring apparatus. The measurement was performed in atmosphere at room temperature. The absorption spectrum peak of a sample obtained by co-vapor deposition of NTCDA/indium shifts by about 70 nm toward longer wavelength side as compared with the case using only NTCDA (FIG. 5).

### (Measurement of ESR Spectrum)

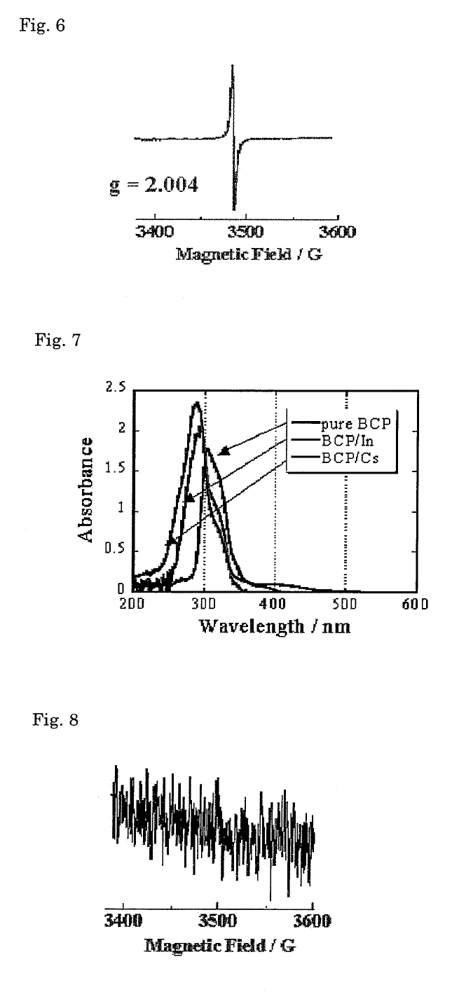

For verifying stability and the presence of free electrons, the ESR spectrum of a sample obtained by co-vapor deposition of NTCDA/indium in an electron spin resonance absorption (ESR) measurement apparatus was measured. Clear ESR spectrum in atmosphere teaches stability in atmosphere, indicating excellent durability. It is understood that free electrons contributing to electron conduction are generated in the layer (FIG. 6).

### COMPARATIVE EXAMPLE 4

### Manufacturing of Sample for Measuring Absorption Spectrum, ESR Spectrum

A washed glass substrate was set on a vacuum vapor deposition machine, and BCP and indium were co-vapor-deposited at sedimentation speeds of 0.45 nm/s and 0.02 nm/s, respectively, so as to give a film thickness of 200 nm together. The proportion of an indium atom per mole of this BCP molecule was one. On the other hand, a sample was also manufactured by vapor-depositing BCP at a sedimentation speed of 0.45 nm/s so as to give a film thickness of 200 nm without vapor deposition of a metal. The degree of vacuum was 1.0×10⁻⁵ Torr or less in all cases.

### (Measurement of Absorption Spectrum)

The measurement environments are the same as in Example 3.

The absorption spectrum peak of a sample obtained by co-vapor deposition of BCP/indium shifts by 10 nm or more toward shorter wavelength side as compared with the case using only BCP (FIG. 7).

### (Measurement of ESR Spectrum)

In measurement of ESR, no clear ESR spectrum shown in atmosphere teaches that the sample of Comparative Example 4 is instable in atmosphere. It is understood that free electrons contributing to electron conduction are not generated in the layer (FIG. 8).

### EXAMPLE 3

### Measurement of Electric Conductivity

### (Manufacturing of Sample for Measurement)

A washed glass substrate was set on a vacuum vapor deposition machine, and as the layer (L), NTCDA and metal atom were co-vapor-deposited at sedimentation speeds of 0.4 nm/s and 0.02 nm/s, respectively, so as to give a film thickness of 200 nm together. The proportion of a metal atom per mole of this NTCDA molecule was one (0.25 metal atoms per carbonyl group). Further, a gold electrode was vapor-deposited as a parallel electrode with an interval of 100 μm using a vapor deposition mask.

On the other hand, BCP and metal atom were co-vapor-deposited at sedimentation speeds of 0.45 nm/s and 0.02 nm/s, respectively, so as to give a film thickness of 200 nm together. Further, a gold electrode was vapor-deposited. The degree of vacuum was 1.0×10⁻⁵ Torr or less in all cases.

### (Manufacturing of Sample for Measurement)

The electric conduction of a co-deposition film obtained by doping a metal atom into NTCDA or BCP was measured by measuring the current quantity when voltage was applied between gold electrodes For measurement, an electro meter was used. The measurement was performed in vacuum at room temperature.

### (Measurement Results)

The results of measurement of the electric conductivity of the film obtained by doping a metal atom into NTCDA or BCP are shown in Table 1. The doping amount of metals is a proportion of one each metal atom per NTCDA or BCP molecule. There is also a case showing improvement in conductivity by 6 digits or more as compared with a case of no doping. When an alkali metal such as lithium, sodium and the like is doped, electric conductivity increases, however, since an alkali metal shows extremely excellent reactivity with water and oxygen, a composition of this metal atom and an organic compound is instable against atmosphere. On the other hand, indium is relatively stable against water and oxygen. When NTCDA and BCP each doped with this indium are compared, NTCDA doped with indium shows an electric conductivity of 9.1×10⁻² S/cm which is higher by about 5 digits or more.

TABLE 1

| | NTCDA | BCP |
|---|---|---|
| Doped metal | (S/cm) | (S/cm) |
| Non | 2.5 × 10⁻⁸ | 5.7 × 10⁻¹¹ |
| In | 9.1 × 10⁻² | 2.0 × 10⁻⁷ |
| Li | 6.1 × 10⁻⁵ | 4.2 × 10⁻⁵ |
| Na | 2.9 × 10⁻² | 5.2 × 10⁻⁵ |
| K | 6.3 × 10⁻² | 9.1 × 10⁻⁵ |
| Rb | 2.0 × 10⁻¹ | 1.4 × 10⁻⁴ |
| Cs | 1.2 × 10⁻¹ | 1.4 × 10⁻⁴ |

The organic EL device of the present invention is excellent in durability, electron injectability and the like.

### INDUSTRIAL APPLICABILITY

A sheet light source, segment display and dot matrix display can be manufactured using the organic electroluminescence device of the present invention. Further, a liquid crystal display can be manufactured using the organic electroluminescence device of the present invention as backlight.

For obtaining light emission in the form of sheet using the organic EL device of the present invention, it is advantageous that an anode and a cathode each in the form of sheet are disposed so as to overlap. For obtaining light emission in the form of pattern, there are a method in which a mask equipped with a window in the form of pattern is disposed on the surface of the above-described sheet light emitting device, a method in which an organic substance layer at no-emitting portions is formed with extremely large thickness to attain substantially no-emission, and a method in which either an anode or a cathode, or both electrode are formed in the form of pattern. By forming a pattern by any of these methods and disposing some electrodes to allow On/OFF independently, a segment type display device which can display numbers, letters, simple marks and the like is obtained. Further, for obtaining a dot matrix device, it may be advantageous that both an anode and a cathode are formed in the form of stripe and disposed so as to cross. Partial color display and multi color display are made possible by a method of coating a plurality of polymer fluorescent substances of different emission colors divisionally, and a method of using a color filter or a fluorescence converting filter. A dot matrix device can be passively driven, and or may be actively driven in combination with TFT and the like. These display devices can be used as a display such as computers, televisions, portable terminals, portable telephones, car navigations, video camera view finders and the like.

Further, the above-described sheet light emitting device is of self-luminous thin type, and can be suitably used as a sheet light source for backlight of a liquid crystal display or a sheet light source for illumination. When a flexible substrate is used, it can also be used as a light source or display in the form of curved surface.

1. An organic electroluminescence device having a light emitting layer between an anode and a cathode wherein the device has a layer (L) between said cathode and said light emitting layer so as to contact the cathode, and the layer (L) comprises an organic compound (A) containing an aromatic hydrocarbon ring or hetero ring and a carbonyl group and a metal (B) selected from alkaline earth metals and group III metals.

2. An organic electroluminescence device having a light emitting layer between an anode and a cathode wherein the device has a layer (L) between said cathode and said light emitting layer so as to contact the cathode, and the layer (L) is obtained by using an organic compound (A) containing an aromatic hydrocarbon ring or hetero ring and a carbonyl group and a metal (B) selected from alkaline earth metals and group III metals.

3. The organic electroluminescence device according to claim 1, wherein a mixture obtained from the organic compound (A) and the metal (B) has an electric conductivity of 10⁻⁶ S/cm or more.

4. The organic electroluminescence device according to claim 1, wherein the absorption peak wavelength of a thin film composed of the organic compound (A) and the metal (B) is larger by 5 nm or more than the absorption peak wavelength of a thin film composed of the organic compound (A).

5. The organic electroluminescence device according to claim 1, wherein the metal (B) is selected from magnesium, calcium, strontium, barium, aluminum, gallium, indium and thallium.

6. The organic electroluminescence device according to claim 1, wherein the organic compound (A) is selected from the following formulae (1), (2), (3) and (4) 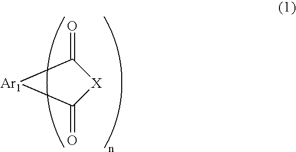
wherein, Ar₁ represents an organic group containing an aromatic hydrocarbon ring or hetero ring; X represents O or NH; n represents an integer of 1 or more and 4 or less; when there are a plurality of Xs, they may be the same or different 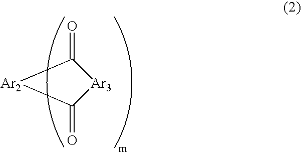
wherein, Ar₂ and Ar₃ represent each independently an organic group containing an aromatic hydrocarbon ring or hetero ring; m represents an integer of 1 or more and 4 or less; when there are a plurality of Ar₃s, they may be the same or different 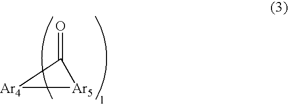
wherein, Ar₄ and Ar₅ represent each independently an organic group containing an aromatic hydrocarbon ring or hetero ring; 1 represents an integer of 1 or more and 4 or less; Ar₅s may be the same or different 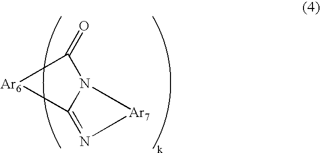
wherein, Ar₆ and Ar₇ represent each independently an organic group containing an aromatic hydrocarbon ring or hetero ring; k represents an integer of 1 or more and 4 or less; when there are a plurality of Ar₇s, they may be the same or different.

7. A sheet light source using the organic electroluminescence device according to claim 1.

8. A segment display using the organic electroluminescence device according to claim 1.

9. A dot matrix display using the organic electroluminescence device according to claim 1.

10. A liquid crystal display using the organic electroluminescence device according to claim 1 as backlight.
